(19) United States
(12) Patent Application Publication
(10) Pub. No.: US 2007/0282782 A1
(43) Pub. Date: Dec. 6, 2007

(54) METHOD, SYSTEM, AND PROGRAM PRODUCT FOR MANAGING INFORMATION FOR A NETWORK TOPOLOGY CHANGE

(76) Inventors: Julie M. Carey, Rye Brook, NY (US); Carol I. DelGaudio, Williston, VT (US); Brenda L. Fowler, Castle Creek, NY (US); Anne M. Henderson, Essex Junction, VT (US); Scott D. Hicks, Underhill Center, VT (US); William M. Houston, Danbury, CT (US); Douglas G. Murray, Johnson City, NY (US); Diane C. Rauch, Sunset Beach, NC (US); Jamie P. Rigoni, Fairfax, VT (US)

Correspondence Address: HOFFMAN, WARNICK & D'ALESSANDRO LLC, 75 STATE ST, 14TH FLOOR, ALBANY, NY, 12207, US

(21) Appl. No.: 11/421,269

(22) Filed: May 31, 2006

(51) Int. Cl. G06F 17/30

(52) U.S. Cl. 707/1

(57) ABSTRACT

Under the present invention, information pertaining to an existing network topology is imported into a migration database. This information typically comprises information about devices in the existing network topology, existing network addresses for the devices, whether each device has a static or a dynamic address, information about locations of the devices, and information about users of the devices. In addition, information pertaining to a new network topology is received in the migration database. This type of information typically comprises new network addresses or ranges of addresses for the devices, network port identifiers, connections to specific closets, racks, and switches, and whether each device requires a static or a dynamic address. Regardless, the information provided will then be sorted according a set of database views, which can then be provided to viewers.

### CROSS-REFERENCE TO RELATED APPLICATION

This application is related in some aspects to the commonly assigned co-pending application identified by application Ser. No. 11/225,608, entitled “Computer-Implemented Method, System, and Program Product for Managing Data for an Information Technology (IT) Migration”, filed Sep. 13, 2005 and herein incorporated by reference.

### FIELD OF THE INVENTION

In general, the present invention relates to information/data management for network topology change such as an Information Technology (IT) migration. Specifically, the present invention provides, among other things, centralized data management and electronic view generation for the network topology change.

### BACKGROUND OF THE INVENTION

As Information Technology (IT) continues to advance, many organizations are faced with the task of changing their network topologies (e.g., migrating their existing computer infrastructures, telephone systems and the like) to newer technology. For example, an organization might wish to migrate its networking functions from token ring to Ethernet. Similarly, an organization might wish to migrate its telephone service from landline-based service to voice-over-IP service.

A network topology change can not only involve adding components such as hardware or software to a computer infrastructure, but it can also involve the physical relocation of existing devices and/or components. To this extent, there are often various pieces of data that are needed or generated for the network topology change. For example, data in a network topology change can include physical location/address information, scheduling information, configuration information, status information, etc. In general, there are often many individuals involved with a network topology change. To perform their jobs, the users generally require access to subsets of the data.

Unfortunately, existing approaches fail to provide a single, integrated system that can be used to manage the data for the network topology change. Specifically, existing approaches consisted of a combination of separate tools, such as e-mail, telephone communications, paper work orders, spreadsheets that contain configuration data, printouts of system configurations, paper or electronic worksheets that contain planned configuration specifications, network configuration databases, or project management applications. Passing the information from one step to the next requires exporting and importing, copying and pasting, printing, or writing to take data from one tool to the next. The status of prerequisite tasks is also currently communicated via e-mail, telephone, etc. As such, use of these disjointed systems is time consuming, labor intensive, and prone to errors.

In view of the foregoing, there exists a need to overcome the deficiencies in the related art.

### SUMMARY OF THE INVENTION

In general, the present invention provides a method, system, and program product for managing information/data for a network topology change such as an IT migration. Specifically, under the present invention, information pertaining to an existing network topology is imported into a migration database. This information typically comprises information about devices in the existing network topology, existing network addresses for the devices, whether each device has a static or a dynamic address, information about locations of the devices, and information about users of the devices. Information about the users of the devices can be imported from a personnel database, while information about the devices themselves can be imported from a software utility and/or manually input. In addition, information pertaining to a new network topology is received in the migration database. This type of information typically comprises new network addresses or ranges of addresses for the devices, network port identifiers, connections to specific closets, racks, and switches, and whether each device requires a static or a dynamic address. Regardless, the information provided will then be sorted according to a set of database views, which can then be provided to viewers.

The present invention also allows a Domain name Server (DNS) to be queried using host names of the devices to determine if the devices have static network addresses. Any static network address that is determined to be un-used, and static network addresses for devices that are assigned new network addresses, are returned to a network address pool. Thereafter, the DNS can be updated to reflect the return of the static network addresses to the network address pool. The unused or old addresses can be reused in other parts of the enterprise.

A first aspect of the present invention provides a method for managing information for a network topology migration, comprising: importing information pertaining to an existing network topology into a migration database, wherein the information pertaining to the existing network topology comprises information about devices in the existing network topology, existing network addresses for the devices, whether each device has a static or a dynamic address, information about locations of the devices, and information about users of the devices; receiving information pertaining to a new network topology in the migration database, wherein the information pertaining to the new network topology comprises new network addresses for the devices; and sorting the information pertaining to the existing network topology and the information pertaining to the new network topology according to a set of database views.

A second aspect of the present invention provides a system for managing information for a network topology migration, comprising: a system for importing information pertaining to an existing network topology into a migration database, wherein the information pertaining to the existing network topology comprises information about devices in the existing network topology, existing network addresses for the devices, whether each device has a static or a dynamic address, information about locations of the devices, and information about users of the devices; a system for receiving information pertaining to a new network topology in the migration database, wherein the information pertaining to the new network topology comprises new network addresses for the devices; and a system for sorting the information pertaining to the existing network topology and the information pertaining to the new network topology according to a set of database views.

A third aspect of the present invention provides a program product stored on a computer useable medium for managing information for a network topology migration, the computer useable medium comprising program code for causing a computer system to perform the following steps: importing information pertaining to an existing network topology into a migration database, wherein the information pertaining to the existing network topology comprises information about devices in the existing network topology, existing network addresses for the devices, whether each device has a static or a dynamic address, information about locations of the devices, and information about users of the devices; receiving information pertaining to a new network topology in the migration database, wherein the information pertaining to the new network topology comprises new network addresses for the devices; and sorting the information pertaining to the existing network topology and the information pertaining to the new network topology according to a set of database views.

A fourth aspect of the present invention provides a method for deploying an application for managing information for a network topology migration, comprising: providing a computer infrastructure being operable to: import information pertaining to an existing network topology into a migration database, wherein the information pertaining to the existing network topology comprises information about devices in the existing network topology, existing network addresses for the devices, whether each device has a static or a dynamic address, information about locations of the devices, and information about users of the devices; receive information pertaining to a new network topology in the migration database, wherein the information pertaining to the new network topology comprises new network addresses for the devices; and sort the information pertaining to the existing network topology and the information pertaining to the new network topology according to a set of database views.

A fifth aspect of the present invention provides a computer software embodied in a propagated signal for managing information for a network topology migration, the computer software comprising instructions for causing a computer system to perform the following steps: importing information pertaining to an existing network topology into a migration database, wherein the information pertaining to the existing network topology comprises information about devices in the existing network topology, existing network addresses for the devices, whether each device has a static or a dynamic address, information about locations of the devices, and information about users of the devices; receiving information pertaining to a new network topology in the migration database, wherein the information pertaining to the new network topology comprises new network addresses for the devices; and sorting the information pertaining to the existing network topology and the information pertaining to the new network topology according to a set of database views.

A sixth aspect of the present invention provides a business method for managing information for a network topology migration

Therefore, the present invention provides a method, system, and program product for managing information/data for a network topology change such as an IT migration.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 depicts a system for managing information for a network topology change according to the present invention.

FIG. 2 depicts an illustrative screen shot according to the present invention.

FIG. 3 depicts another illustrative screen shot according to the present invention.

FIG. 4 depicts another illustrative screen shot according to the present invention.

FIG. 5 depicts another illustrative screen shot according to the present invention.

FIG. 6 depicts another illustrative screen shot according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### BEST MODE FOR CARRYING OUT THE INVENTION

As indicated above, the present invention provides a method, system, and program product for managing information/data for a network topology change such as an IT migration. Specifically, under the present invention, information pertaining to an existing network topology is imported into a migration database. This information typically comprises information about devices in the existing network topology, existing network addresses for the devices, whether each device has a static or a dynamic address, information about locations of the devices, and information about users of the devices. Information about the users of the devices can be imported from a personnel database, while information about the devices themselves can be imported from a software utility and/or manually input. In addition, information pertaining to a new network topology is received in the migration database. This type of information typically comprises new network addresses or ranges of addresses for the devices, network port identifiers, connections to specific closets, racks, and switches, and whether each device requires a static or a dynamic address. Regardless, the information provided will then be sorted according a set of database views, which can then be provided to viewers.

The present invention also allows a Domain name Server (DNS) to be queried using host names of the devices to determine if the devices have static network addresses. Any static network address that is determined to be un-used, and static network addresses for devices that are assigned new network addresses, are returned to a network address pool. Thereafter, the DNS can be updated to reflect the return of the static network addresses to the network address pool.

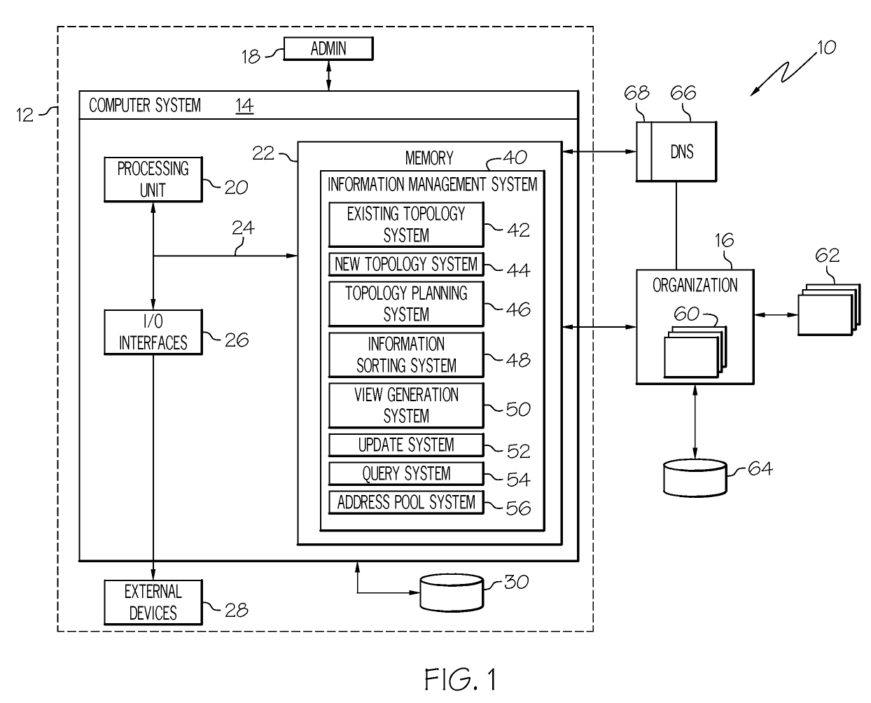

Referring now to FIG. 1, a system 10 for managing data for a network topology change (such as an IT migration) is shown. As depicted, system 10 includes a computer system 14 deployed within a computer infrastructure 12. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 12 is intended to demonstrate that some or all of the components of system 10 could be deployed, managed, serviced, etc. by a service provider who offers to manage information for network topology change being performed for organization 16.

As shown, computer system 14 includes a processing unit 20, a memory 22, a bus 24, and input/output (I/O) interfaces 26. Further, computer system 14 is shown in communication with external I/O devices/resources 28 and storage system 30. In general, processing unit 20 executes computer program code, such as information management system 40, which is stored in memory 22 and/or storage system 30. While executing computer program code, processing unit 20 can read and/or write data to/from memory 22, storage system 30, and/or I/O interfaces 26. Bus 24 provides a communication link between each of the components in computer system 14. External devices 28 can comprise any devices (e.g., keyboard, pointing device, display, etc.) that enable a user to interact with computer system 14 and/or any devices (e.g., network card, modem, etc.) that enable computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the various process steps of the invention. Moreover, computer system 14 is only representative of various possible computer systems that can include numerous combinations of hardware. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28.

Still further, it is understood that one or more additional components (e.g., system software, math co-processing unit, etc.) not shown in FIG. 1 can be included in computer system 14. However, if computer system 14 comprises a handheld device or the like, it is understood that one or more external devices 28 (e.g., a display) and/or storage system(s) 30 could be contained within computer system 14, not externally as shown.

Storage system 30 can be any type of system (e.g., a database) capable of providing storage for information under the present invention, such existing network topology information, new network work topology information, etc. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). In a typical embodiment, storage system 30 is a single migration database 30 in which network topology migration information is stored. Although not shown, additional components, such as cache memory, communication systems, system software, etc., may be incorporated into computer system 14.

Shown in memory 22 of computer system 14 is information management system 40, which includes existing topology system 42, new topology system 44, topology planning system 46, information sorting system 48, view generation system 50, update system 52, query system 54, and address pool system 56. These systems will provide the functionality of the present invention. It should be understood, however, that the same functionality could be provided with a different configuration of systems than is shown in FIG. 1.

In an illustrative assume that a physical migration of network topology from an existing network topology to a new network topology is to be performed for organization 16. Further assume that this involves a migration of network addresses for devices 60 from existing/old network addresses to new network addresses. Examples of devices 60 could include data processing devices such as computer systems, output devices such as printers, input devices such as barcode or badge readers, and/or non data processing systems such as routers or switches. As such, devices 60 may or may not be directly operated by users 62.

As part of the network topology change, further assume that old network addresses have to be returned to the network address administrator; Dynamic Host Configuration Protocol (DHCP) pools were configured and tested; and static network addresses were assigned as needed. Still further, assume that the configuration of devices 60 and “closets” are planned and carried out using the integrated information structure of the present invention and associated tools. As will be further illustrated, the present invention allows the network address information to be associated with other information such as with physical location information (building, floor, and office data) to allow a building floor plan to be overlain with network address, network port identifiers, and network configuration data (e.g., mapping out service areas for each closet or network infrastructure device).

Under the present invention, information pertaining to the existing network topology of organization 16 will be imported by existing topology system 42 into a (single) migration database 30. In a typical embodiment, the information pertaining to the existing network topology. This information typically comprises information about devices 60 in the existing network topology, existing network addresses for devices 60, whether each device 60 has a static or a dynamic address, information about locations of the devices, and information about users 62 of devices 60. Information about users 62 can include any pieces of descriptive information such as names, addresses, physical locations, network port identifiers, identification numbers of users 62, etc. Information about users 62 is typically imported from a personnel database 64. The information about devices 60 can be imported from a software utility running on devices 60, remotely from other devices that were used to capture the information and/or imported based on manual input from an administrator 18, service personnel, or the like (e.g., laptops operated by service personnel performing the topology migration). The information about the devices 60 can be any type of information that describes the resources and/or functions of devices 60. Such information could include, for example, information about the hardware/software installed on devices 60. The existing network addresses that are imported by existing topology system 42 could be imported using the software utility, from another data storage unit, from other devices, or based upon manual input. Regardless, all pieces of information pertaining to the existing network topology will be stored in migration database 30.

New topology system 44 will receive information pertaining to the new network topology for organization 16, and place the same in migration database 30. This type of information typically comprises new network addresses or ranges of addresses for devices 60, network port identifiers, connections to specific closets, racks, and switches, and whether each device 60 requires a static or a dynamic address. This information will be associated with the information pertaining to the existing network topology for each corresponding device 60 in migration database 30.

Also shown in FIG. 1, is optional topology planning system 46, which can be used to plan the network topology migration. Specifically, topology planning system 46 could be used to receive (for storage in migration database 30) information (e.g., scheduling information) about a planned network topology migration, to present information about what is required for a desired topology migration, etc. For example topology planning system 46 could allow administrator (or another individual planning the migration) to select a specific migration-related activity. Examples of migration activities could include, for example, designing a Virtual Local Area Network (VLAN), defining a DCHP address pool, assigning static network addresses to the devices, recovering unused network addresses, and planning a network closet configuration. To this extent, topology planning system 46 could provide a set of interfaces, views and/or wizards that receive information for storage in migration database 30 (e.g., scheduling information) and/or present information (e.g., descriptions, task lists, etc.) to one or more individuals. In the case that topology planning system 46 presents information, such information could be derived from another source (not shown) external to computer system 14.

In another embodiment, topology planning system 46 allows a “request” to change the network topology from the existing network topology to the new network topology to be generated and sent to appropriate individuals (e.g., service personnel). This can occur, for example, automatically when a change is made to the information pertaining to the existing network topology. That is, if a new network address is added to migration database for a certain device (e.g., via new topology system 44), topology planning system 46 could automatically generate a request (e.g., electronic request) for the change to formally/physically be made, and send the request to the appropriate service personnel.

In any event, the information stored in migration database 30 will be sorted by information sorting system 48 according to a set (e.g., at least one) of database views. Specifically, customized database views of the information data can developed to present the information needed by service personnel to perform the various migration tasks. Thereafter, view generation system 50 will generate and present the set of views as requested. To this extent, view generation system 50 could generate the set of database views based on an attribute of the requesting individual (e.g., the individual's role or “permissions to see the information, based on the information that is desired to be viewed, etc.

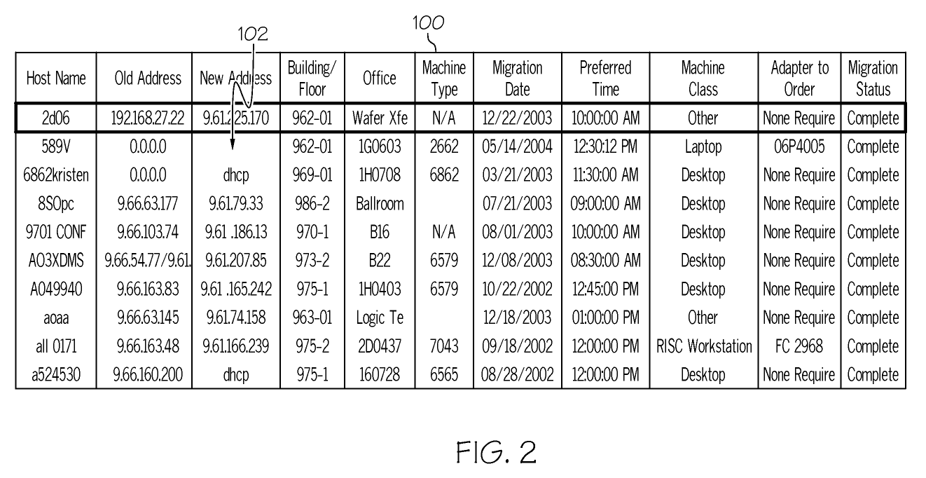

Referring to FIG. 2, an illustrative database view 100 is depicted that shows old addresses (that can be recovered), along with new addresses and location information for devices 60 (FIG. 1). Specifically, view 100 includes a set of table entries 102 that show devices 60, according to corresponding host name, old network address, new network address, location, machine type, and migration schedule. Database view 100 can further show devices 60 according to corresponding machine class, parts (e.g., network adapter) to order and migration status.

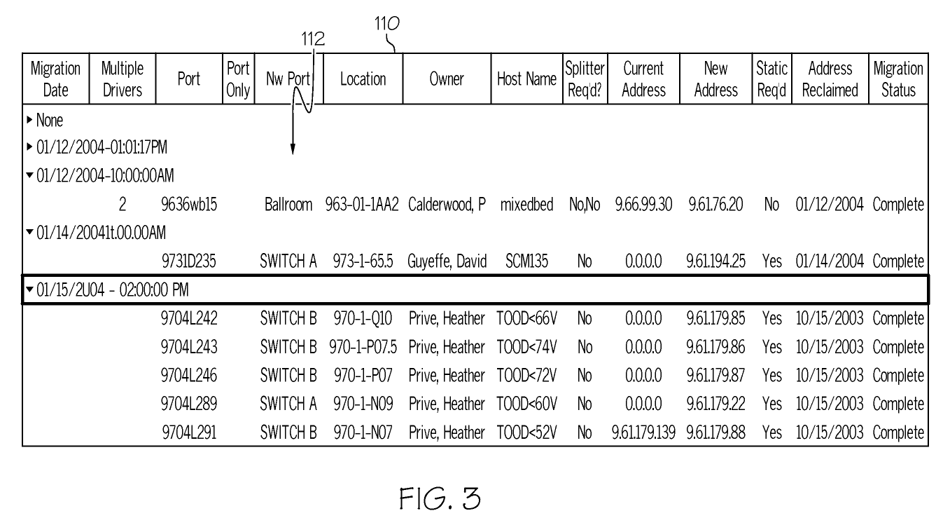

It should be understood that information sorting system 48 and view generation system 50 need not only perform their functions with respect to devices 60. Rather, database views for other aspects of the migration (e.g., network ports) can be generated and presented. Referring to FIG. 3, another illustrative database view 110 is depicted that shows network ports to be migrated on successive dates, with the network addresses, locations, and user information. Specifically, database view 110 includes a set of table entries 102 that show network ports to be migrated according to corresponding migration date, driver information, network port information, location information, user/owner information, host name, splitter information, old/current network address and new network address.

In one specific aspect, the present invention allows information surrounding the assignment of new static network addresses to devices 60 (FIG. 1) to be managed. Specifically, prior to the present invention, there did not exist a tool or process to manage existing customer static TCP/IP addresses, and allow individuals (e.g., service personnel) in other locations to assign new static network addresses in a large scale (site-wide or multi-location) migration from a database. To this extent, existing solutions require that a form (either hardcopy or softcopy) be filled out by the requester and submitted to the individual responsible for assigning static IP addresses. The IP Address Administrator would then manually assign the address, notify the requester, and make any updates. In addition, filling out a form involves researching, transcribing or copying much of the information from other sources. The form would then have to be sent to the IP Administration Team, and be placed in their work queue. The IP Administration Team would sometimes have to obtain additional information from other teams, such as the Network team that is configuring switches and patch panels in the wiring closets. This requires phone calls or e-mails and additional time. When the new address is assigned, it would then have to be entered into an online system. The requester would have to log in to that system to obtain the new address.

By leveraging information management system 40 (FIG. 1) and migration database 30 (FIG. 1) all of the information needed by all “key” individuals to retire old static TCP/IP addresses and assign new static network addresses as part of a large scale IT migration is available. All key individuals can be given access to the migration database 30, and can verify if an organization or component thereof is ready to be migrated well in advance of the scheduled migration time. Among other things, this eliminates the need to fill out a form or document requesting action by the IP Administration Team.

Specifically, as indicated above, the present invention places all of the information about the device, the owner, and the network connection in the single migration database 30, and makes the same accessible at all times by all team members. Records can be updated or retrieved on demand. The work of retiring old static network addresses and assigning new static network addresses can be automatically scheduled to meet the needs of the overall project by looking in a view that organizes the records by the scheduled migration date and time.

When the migration involves assignment of new static network addresses to devices 60, old addresses should be returned to the network address administrator, and a new static network address assigned and tested. Under the present invention, to achieve minimum device 60 downtime, a new static network address is pre-assigned by administrator 18. As the hardware inventory of devices 60 is conducted, records are created in migration database 30, with fields indicating which devices have existing static network addresses, and which devices require new static network addresses. The records of devices 60 that require static network addresses are placed in a special view in the database. The IP Administration Team has access to migration database 30 and would recognize a new record in the view, know it requires a new address and after issuing a new address, they would update the record in migration database 30 (e.g., via new topology system 44). Using techniques similar to that described above, information sorting system 48 can sort the information and view generation system 50 can generate and present a set of database views that focus on the static network address updates.

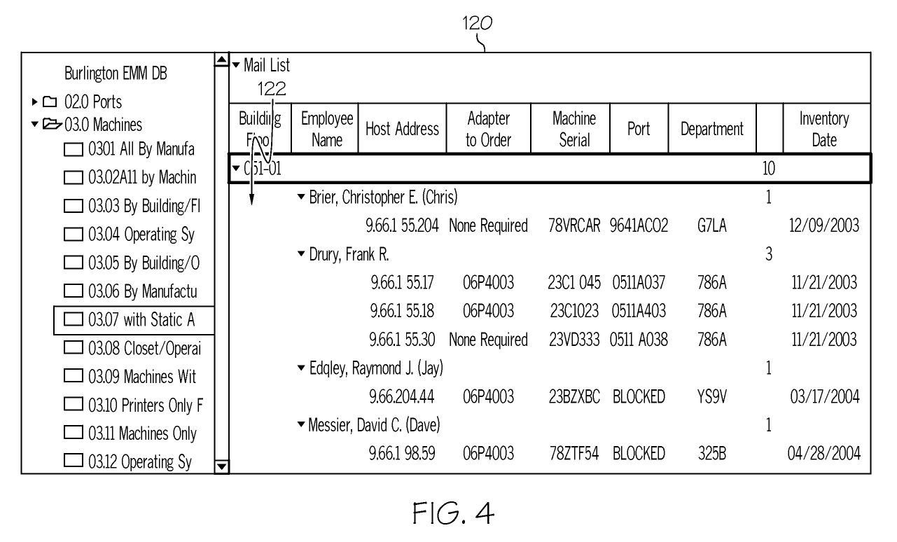

Referring to FIG. 4, an illustrative database view 120 having table entries 122 that show devices 60 by corresponding building, floor, and owner. Database view 120 can further show devices 60 according to corresponding host address, part (e.g., adapter) to order, device/machine serial number, port, department, and inventory date.

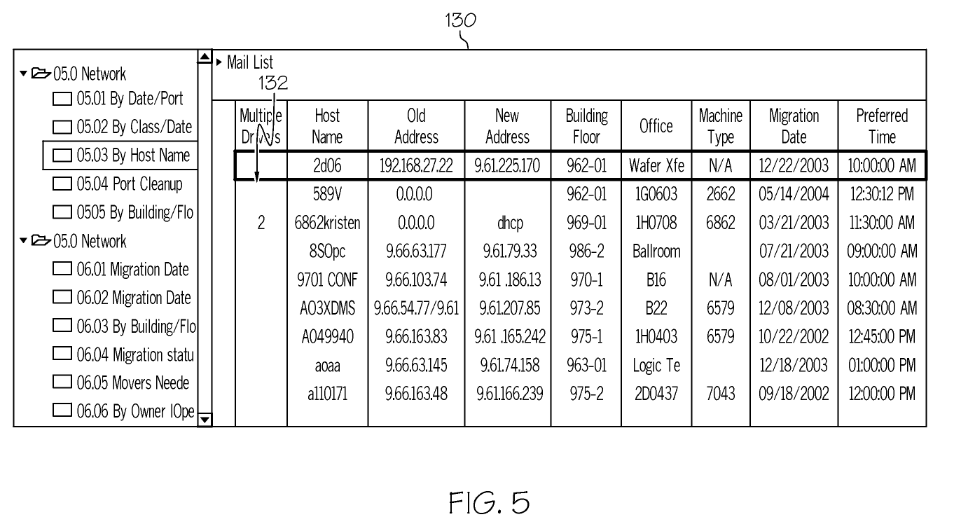

Referring to FIG. 5, another illustrative database view 130 having entries 132 is depicted that shows devices 60 according to corresponding Internet Protocol (IP) hostnames, the old network addresses, and the new (e.g., static) network addresses. Database view 130 can further show corresponding building/floor information, office information, machine type/device information, etc. Further, in showing the network address information, database view 130 can show whether the network addresses are static or assigned by DHCP.

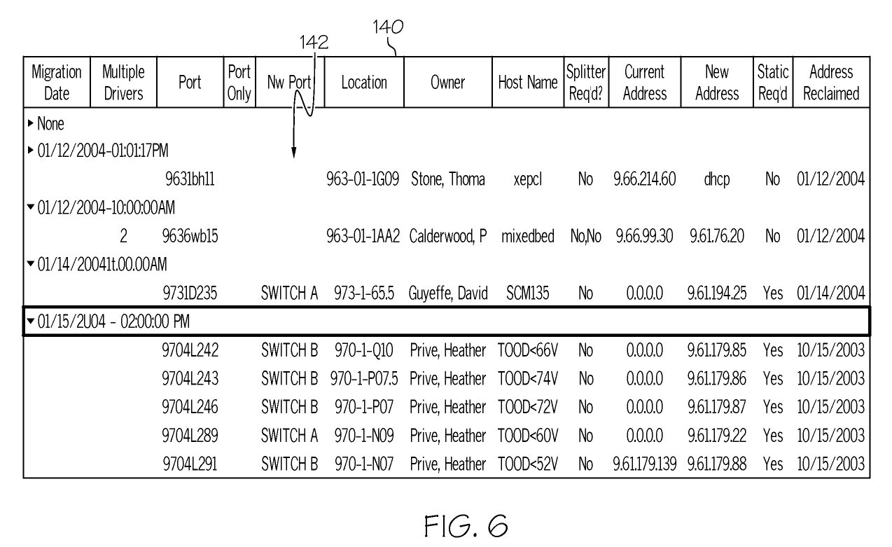

Referring to FIG. 6, another illustrative database view 140 having entries 142 is shown. Among other things, database view 140 shows migrations according to corresponding scheduled date and time, contains information on static network address requirements, and shows and old and new static network addresses. Database view 140 further shows corresponding port information, location information, host name information, and requirement information (e.g., splitter requirements).

Referring back to FIG. 1, information management system 40 further includes update system 52. Occasionally, information in migration database 30 may need to be changed (e.g., due to errors, changes in scheduling, changes in the planned migration etc.). To this extent, update system 52 allows any information in migration database 30 to be updated as needed. To prevent erroneous changes, update date 52 could limit such updates to appropriate personnel (e.g., certain roles, permission levels, etc.).

In yet another specific embodiment, the present invention allows unused or old static network addresses to be returned to a network address pool. Specifically, as the networking has matured through the years, machines such as devices 60 are converted from fixed or static to dynamic network addressing. As this is done, the old static network addresses are often not returned to the pool of addresses that can be reused. If an old static network address is not recovered at the same time that a machine is converted to a dynamic network address, then it will most likely not be returned to the pool in the future because it can not be known whether the network address is being used. These un-recovered static network addresses then cause another problem. That is, these addresses can not be added to the dynamic address pool thus causing a shortage of dynamic network addresses. In addition if there is a static address assigned to a machine and the machine is using dynamic addressing then the resolution of the machines host name will not yield the correct address.

The present invention provides a way to ask a domain name server (DNS) 66 if a given device 60 has a static address assigned. If one is found, it is compared to the address settings on device 60 and reported as a static network address that is not in use if the network address reported by the name server is not in use by the device 60. Specifically, an interface 68 to DNS 68 is provided. This interface 68 is typically implemented as a URL request that this implementation sends. The result of the request contains the information needed to determine if a static network address exists for a given host name.

That is, during the gathering of other needed information, the host name of the device 60 is looked up on DNS 66. This typically occurs via a query from query system 54. If a static network address is found for the device 60, it will be returned along with the other information being collected. During the assignment of the new network addresses, this static network address is then removed from the static pool and returned to the dynamic pool by address pool system 56 so that the host name resolution works correctly and the dynamic address pool is replenished.

While shown and described herein as a method and system for managing information for network topology change, it is understood that the invention further provides various alternative embodiments. For example, in one embodiment, the invention provides a computer-readable/useable medium that includes computer program code to enable a computer infrastructure to manage information for network topology change. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to manage information for network topology change. In this case, the service provider can create, maintain, support, etc., a computer infrastructure, such as computer infrastructure 12 (FIG. 1) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for managing information for network topology change. In this case, a computer infrastructure, such as computer infrastructure 12 (FIG. 1), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for managing information for a network topology migration, comprising:
importing information pertaining to an existing network topology into a migration database, wherein the information pertaining to the existing network topology comprises information about devices in the existing network topology, existing network addresses for the devices, whether each device has a static or a dynamic address, information about locations of the devices, and information about users of the devices;
receiving information pertaining to a new network topology in the migration database, wherein the information pertaining to the new network topology comprises new network addresses for the devices; and
sorting the information pertaining to the existing network topology and the information pertaining to the new network topology according to a set of database views.

2. The method of claim 1, further comprising planning a new network topology.

3. The method of claim 2, wherein the planning comprises at least one activity selected from the group consisting of designing a Virtual Local Area Network (VLAN), defining a Dynamic Host Configuration Protocol (DCHP) address pool, assigning static network addresses to the devices, recovering unused network addresses, and planning a network closet configuration.

4. The method of claim 1, further comprising generating a work request to change the existing network topology by updating the information pertaining to the existing network topology in the migration database.

5. The method of claim 1, wherein the set of database views comprise a first database view that shows the devices according to host name, old network address, new network address, location, machine type and migration schedule.

6. The method of claim 1, wherein the new network topology comprises an assignment of new static network addresses to the devices.

7. The method of claim 6, wherein the set of database views comprises a second database view that shows the devices according to building, floor and user.

8. The method of claim 6, wherein the set of database views comprises a third database view that shows the devices according to Internet Protocol (IP) hostnames, the old static network addresses, and the new static network addresses.

9. The method of claim 1, further comprising querying a Domain name Server (DNS) using host names of the devices to determine if the devices have static network addresses.

10. The method of claim 9, wherein the static network addresses for any of the devices that are assigned new network addresses are returned to a network address pool, and wherein the method further comprises updating the DNS to reflect the return of the static network addresses to the network address pool.

11. The method of claim 1, wherein the migration database comprises a single database, wherein the information about the users of the devices is imported from a personnel database, and wherein the information about the devices is imported from a software utility.

12. A system for managing information for a network topology migration, comprising:
a system for importing information pertaining to an existing network topology into a migration database, wherein the information pertaining to the existing network topology comprises information about devices in the existing network topology, existing network addresses for the devices, whether each device has a static or a dynamic address, information about locations of the devices, and information about users of the devices;
a system for receiving information pertaining to a new network topology in the migration database, wherein the information pertaining to the new network topology comprises new network addresses for the devices; and
a system for sorting the information pertaining to the existing network topology and the information pertaining to the new network topology according to a set of database views.

13. The system of claim 12, further comprising a system for planning a new network topology.

14. The system of claim 13, wherein the system for planning fosters at least one activity selected from the group consisting of designing a Virtual Local Area Network (VLAN), defining a Dynamic Host Configuration Protocol (DCHP) address pool, assigning static network addresses to the devices, recovering unused network addresses, and planning a network closet configuration.

15. The system of claim 12, further comprising a system for generating a work request to change the existing network topology by updating the information pertaining to the existing network topology in the migration database.

16. The system of claim 12, wherein the set of database views comprise a first database view that shows the devices according to host name, old network address, new network address, location, machine type and migration schedule.

17. The system of claim 12, wherein the new network topology comprises an assignment of new static network addresses to the devices.

18. The system of claim 17, wherein the set of database views comprises a second database view that shows the devices according to building, floor and user.

19. The system of claim 17, wherein the set of database views comprises a third database view that shows the devices according to Internet Protocol (IP) hostnames, the old static network addresses, and the new static network addresses.

20. The system of claim 12, further comprising a system for querying a Domain name Server (DNS) using host names of the devices to determine if the devices have static network addresses.

21. The system of claim 20, wherein the static network addresses for any of the devices that are assigned new network addresses are returned to a network address pool when after the assignment of the new network addresses, and wherein the method further comprises updating the DNS to reflect the return of the static network addresses to the network address pool.

22. The system of claim 12, wherein the migration database comprises a single database, wherein the information about the users of the devices is imported from a personnel database, and wherein the information about the devices is imported from a software utility.

23. A program product stored on a computer useable medium for managing information for a network topology migration, the computer useable medium comprising program code for causing a computer system to perform the following steps:
import information pertaining to an existing network topology into a migration database, wherein the information pertaining to the existing network topology comprises information about devices in the existing network topology, existing network addresses for the devices, whether each device has a static or a dynamic address, information about locations of the devices, and information about users of the devices;
receive information pertaining to a new network topology in the migration database, wherein the information pertaining to the new network topology comprises new network addresses for the devices; and
sort the information pertaining to the existing network topology and the information pertaining to the new network topology according to a set of database views.

24. The program product of claim 23, the computer useable medium further comprising program code for causing the computer system to perform the following step: planning a new network topology.

25. The program product of claim 24, wherein the planning comprises at least one activity selected from the group consisting of designing a Virtual Local Area Network (VLAN), defining a Dynamic Host Configuration Protocol (DCHP) address pool, assigning static network addresses to the devices, recovering unused network addresses, and planning a network closet configuration.

26. The program product of claim 23, the computer useable medium further comprising program code for causing the computer system to perform the following step: generating a work request to change the existing network topology by updating the information pertaining to the existing network topology in the migration database.

27. The program product of claim 23, wherein the set of database views comprise a first database view that shows the devices according to host name, old network address, new network address, location, machine type and migration schedule.

28. The program product of claim 23, wherein the new network topology comprises an assignment of new static network addresses to the devices.

29. The program product of claim 28, wherein the set of database views comprises a second database view that shows the devices according to building, floor and user.

30. The program product of claim 28, wherein the set of database views comprises a third database view that shows the devices according to Internet Protocol (IP) hostnames, the old static network addresses, and the new static network addresses.

31. The program product of claim 23, the computer useable medium further comprising program code for causing the computer system to perform the following step: querying a Domain name Server (DNS) using host names of the devices to determine if the devices have static network addresses.

32. The program product of claim 23, wherein the static network addresses for any of the devices that are assigned new network addresses are returned to a network address pool, and wherein the method further comprises updating the DNS to reflect the return of the static network addresses to the network address pool.

33. The program product of claim 23, wherein the migration database comprises a single database, wherein the information about the users of the devices is imported from a personnel database, and wherein the information about the devices is imported from a software utility.

34. A method for deploying an application for managing information for a network topology migration, comprising:
providing a computer infrastructure being operable to:
importing information pertaining to an existing network topology into a migration database, wherein the information pertaining to the existing network topology comprises information about devices in the existing network topology, existing network addresses for the devices, and information about users of the devices;
receiving information pertaining to a new network topology in the migration database, wherein the information pertaining to the new network topology comprises new network addresses for the devices; and
sorting the information pertaining to the existing network topology and the information pertaining to the new network topology according to a set of database views.
